(19) United States
(12) Patent Application Publication
(10) Pub. No.: US 2014/0032833 A1
(43) Pub. Date: Jan. 30, 2014

(54) Dynamic Disk Space Management In A File System

(71) Applicants: Gary D. Cudak, Creedmoor, NC (US); Chistopher J. Hardee, Raleigh, NC (US); Randall C. Humes, Raleigh, NC (US); Ruthie D. Lyle, Durham, NC (US); Adam Roberts, Moncure, NC (US)

(72) Inventors: Gary D. Cudak, Creedmoor, NC (US); Chistopher J. Hardee, Raleigh, NC (US); Randall C. Humes, Raleigh, NC (US); Ruthie D. Lyle, Durham, NC (US); Adam Roberts, Moncure, NC (US)

(73) Assignee: INTERNATIONAL BUSINESS MACHINES CORPORATION, Armonk, NY (US)

(21) Appl. No.: 13/558,057

(22) Filed: Jul. 25, 2012

(51) Int. Cl. G06F 12/00

(52) U.S. Cl. 711/112; 711/E12.001

(57) ABSTRACT

Dynamic disk space management in a file system, including: assigning, by a disk utilization manager upon creation of each file in the file system, a unique identifier to the file; tracking, by the disk utilization manager for each file in the file system, file characteristics in dependence upon the unique identifier of the file; prioritizing, by the disk utilization manager in dependence upon the tracked file characteristics and a predefined set of prioritization criteria, files in the file system; tracking, by the disk utilization manager, utilization of disk drive space; and, upon utilization of disk drive space exceeding a predetermined maximum threshold, reducing, by the disk utilization manager in dependence upon the priorities of files, disk drive space utilization to no greater than a predetermined capacity.

### BACKGROUND OF THE INVENTION

1. Field of the Invention

The field of the invention is data processing, or, more specifically, methods, apparatus, and products for dynamic disk space management in a file system.

2. Description of Related Art

Users of computer systems today may be unable to track disk space usage or maintain orderly file and data organization during use. As a result, disk space is often utilized inefficiently and files may become difficult to locate over time. Further, multiple copies of one file may often exist in various forms on a user's computer system further exacerbating issues with disk space utilization and ease of locating a particular file in the file system.

### SUMMARY OF THE INVENTION

Methods, apparatus, and products for dynamic disk space management in a file system are disclosed in this specification and include: assigning, by a disk utilization manager upon creation of each file in the file system, a unique identifier to the file; tracking, by the disk utilization manager for each file in the file system, file characteristics in dependence upon the unique identifier of the file; prioritizing, by the disk utilization manager in dependence upon the tracked file characteristics and a predefined set of prioritization criteria, files in the file system; tracking, by the disk utilization manager, utilization of disk drive space; and, upon utilization of disk drive space exceeding a predetermined maximum threshold, reducing, by the disk utilization manager in dependence upon the priorities of files, disk drive space utilization to no greater than a predetermined capacity.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system for dynamic disk space management in a file system according to embodiments of the present invention.

FIG. 2 sets forth a flow chart illustrating an exemplary method for dynamic disk space management in a file system according to embodiments of the present invention.

FIG. 3 sets forth a flow chart illustrating a further exemplary method for dynamic disk space management in a file system according to embodiments of the present invention.

FIG. 4 sets forth a flow chart illustrating a further exemplary method for dynamic disk space management in a file system according to embodiments of the present invention.

FIG. 5 sets forth a flow chart illustrating a further exemplary method for dynamic disk space management in a file system according to embodiments of the present invention.

FIG. 6 sets forth a flow chart illustrating a further exemplary method for dynamic disk space management in a file system according to embodiments of the present invention.

### DETAILED DESCRIPTION OF EXEMPLARY EMBODIMENTS

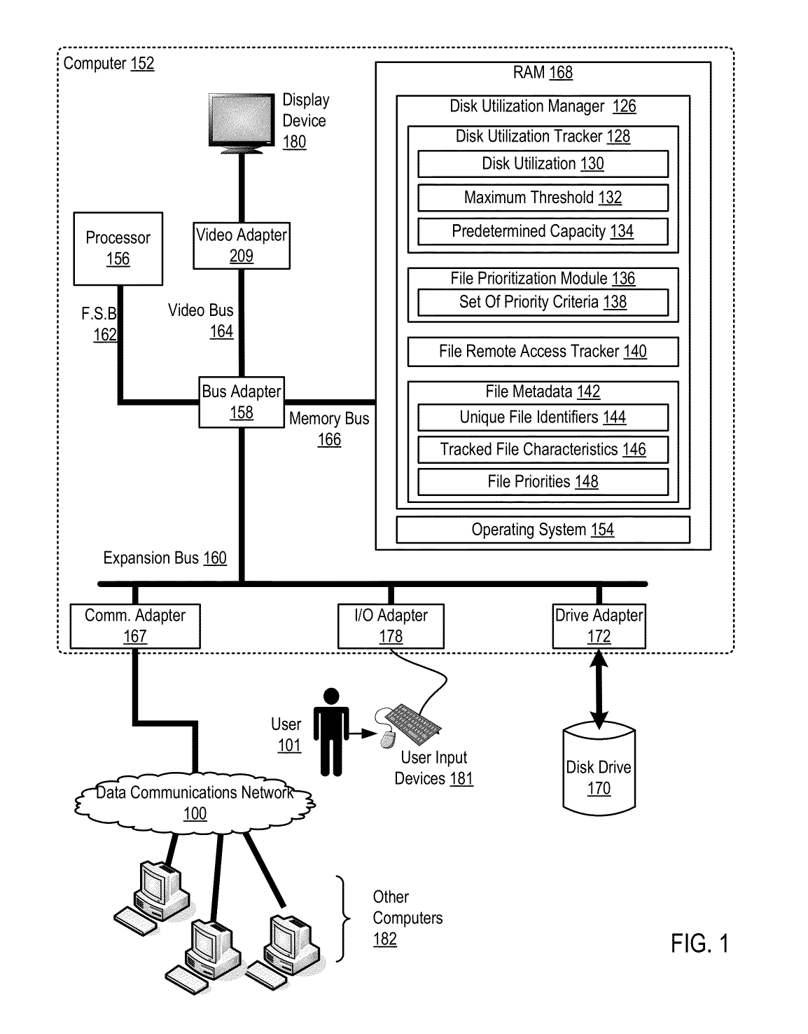

Exemplary methods, apparatus, and products for dynamic disk space management in a file system in accordance with the present invention are described with reference to the accompanying drawings, beginning with FIG. 1. FIG. 1 sets forth a block diagram of an example system for dynamic disk space management in a file system according to embodiments of the present invention. The system of FIG. 1 includes automated computing machinery comprising an exemplary computer (152) useful in dynamic disk space management in a file system according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a disk utilization manager (126), a module of computer program instructions that when executed by the computer processor (156) of FIG. 1 causes the computer (152) to dynamically manage disk space in a file system according to embodiments of the present invention. A file system as the term is used here generally refers to an refers to predefined organization of data expected to be retained after a program terminates by providing procedures to store, retrieve and update data, as well as manage the available space on the device(s) which contain the data. A tight coupling usually exists between the operating system and the file system. Some file systems provide mechanisms to control access to the data and metadata. Ensuring reliability is a major responsibility of a file system. The file system in the example of FIG. 1 may be stored on the disk drive (170). A disk drive has a finite size or capacity.

The example disk utilization manager (126) of FIG. 1 manages utilization of the disk drive (170) in accordance with embodiments of the present invention by: assigning, upon creation of each file in the file system, a unique identifier (144) to the file. A unique identifier is any type of identifier (numeric, alphanumeric, or otherwise) associated only with one file. A unique identifier of a file as the term is used in this specification is contrasted with other forms of file identifiers such as a file's name or a file's storage location in a file system (the file's pathname) which may change over time due to movement of the file, separate copies or downlevel instantiations of the file, and so on. A file's unique identifier, however, is always associated with the file regardless of the file's storage location, separate instantiation, or the like. In the example of FIG. 1, the disk utilization manager assigns the unique identifier to a file by storing the identifier in file metadata (142). A file's unique identifier may be associated in the metadata with the file's current storage location in the filesystem, a date of creation, or any other data describing the file.

The example disk utilization manager (128) of FIG. 1 also tracks, for each file in the file system, file characteristics (146) in dependence upon the unique identifier of the file. File characteristics may include, but are not limited to: file system location of each instance of the file; size of the file; file type; dates of accesses of the file; dates of file content modifications; dates of file backups; emails sent with the file as an attachment; movement of the file from one disk drive to another disk drive; instantiations of downlevel versions of the file, and the like.

Upon a move, copy, deletion, duplication, or other modification for example, the disk utilization manager (126) updates the file metadata (142). The disk utilization manager (128), through use of the file remote access tracker (140), may also track a file's remote accesses and movements to a remote storage location. Such remote accesses may be accesses by remote users operating other computers (182) for purposes of collaboration. Movements to a remote storage location may include an indication that the file was emailed to a recipient as an attachment, stored in a storage area network, uploaded to an offsite storage location, and the like.

The disk utilization manager (126), through the file prioritization module (136), prioritizes files in the file system in dependence upon the tracked file characteristics (146) and a predefined set of prioritization criteria (138). The predefined set of prioritization criteria (138) as the term is used in this specification refers to a specification of conditions and a rulesest that governs prioritizing files in accordance with the conditions. The prioritization criteria may be ‘predefined’ in various ways, including for example, by a user or by a system administrator through a system policy that applies to multiple computer systems. Examples of such criteria may include: number of accesses, time of access, size of file, file types, storage locations, collaborative active from remote users, number of times a file is emailed, inclusion of the file in a recent backup, age of file, revision number, ease of access to file for restoration purposes, and so on. The predefined criteria may also exempt files from prioritization and thus exempt the files from disk space management techniques described below in greater detail, such as moving files, deleting files, or otherwise modifying files for the purpose of managing disk utilization. A user, for example, may specify such files as being exempt by file characteristics or by identification of a file (whether by unique identifier or by the file's current name or pathname). Consider, as an example, that a user specifies all text files to be exempt, or all files accessed within the last seven days to be exempt, or files stored in a particular directory to be exempt, and so on.

The example disk utilization manager (126) in the system of FIG. 1 is also configured to track, through use of the disk utilization tracker (128), utilization of disk drive space. Tracking such utilization of disk drive space may be carried out in various ways including periodically polling the operating system (154) for disk space utilization.

Upon utilization of disk drive space exceeding a predetermined maximum threshold (132), the disk utilization manager (126) reduces disk drive space utilization to no greater than a predetermined capacity in dependence upon the priorities (148) of files. The disk utilization manager (126) may reduce disk utilization in various ways including, for example, by moving files to another disk drive either local or remotely accessible via a network (100), by deleting one or more files, by compressing one or more files, and the like. In some embodiments, when the disk utilization manager (126) deletes a file, the manager may also include storing information describing a method of recovering the deleted file which may be accessed by the user. Such information may be stored in a report, generated by the disk utilization manager (126) and provided to the user (101) or may be stored as a file in the storage location of the deleted file. That is, the disk utilization manager (126) may store, in the deleted file's place, a ‘link’ or ‘pointer’ to another copy of the file, to instructions for recovering the deleted file from a backup, or the like.

The term ‘dynamic’ in this specification refers to disk space management that is carried out during operation of a computer system, generally without user interaction. In this way, disk utilization may be managed during system use, automatically without a user's direct interaction. Consider an example: A user, Jack, operates the computer (152) for a year, during which time the disk drive (170) reaches the system policy threshold (132) of 90% utilization. The disk utilization manager, in accordance with the file priorities, reduces the disk utilization without Jack's interaction to below the minimum threshold of 50%. The disk utilization manager in reducing the disk utilization may identify several large files that share a unique identifier (thus the single file has many duplicates), deleting older versions of the file or moving the older versions to another accessible medium. The disk utilization manager may also identify another set of files for which multiple backups have been recorded and which Jack has not accessed for 10 months. The disk utilization manager may delete these files, leaving in their place a much smaller text file including instructions to recover the deleted files from the backup or a ‘shortcut’ to the file itself within the backup. The disk utilization manager may continue to reduce disk utilization by identifying files with low priority and deleting or moving the files to another accessible medium in the disk utilization is below 50%.

Although the disk utilization manager (126) in the example of FIG. 1 is depicted as including the disk utilization tracker (128), file prioritization tracker (128), file remote access tracker (136), and file metadata, readers of skill in the art will recognize that such components may be stand-alone components operated at the behest of or regularly polled for information by the disk utilization manger (128). Whether implemented as a single set of computer program instructions with multiple sub-components or as several separate modules of computer program instructions, this specification refers to the operation of the entire combination of these modules as the operation of the disk utilization manager for clarity of explanation, not limitation.

Also stored in RAM (168) is an operating system (154). Operating systems useful in systems configured for dynamic disk space management in a file system according to embodiments of the present invention include UNIX™, Linux™, Microsoft XP™, AIX™, IBM's i5/OS™, and others as will occur to those of skill in the art. The operating system (154), disk utilization manager (126), disk utilization tracker (128), file prioritization module (136), file remote access tracker (140), and file metadata (142) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for dynamic disk space management in a file system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user (101) input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in systems configured for dynamic disk space management in a file system according to embodiments of the present invention include modems for wired dial-up communications, Ethernet (IEEE 802.3) adapters for wired data communications, and 802.11 adapters for wireless data communications.

The arrangement of computing components, computers, and other devices making up the exemplary system illustrated in FIG. 1 are for explanation, not for limitation.

Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

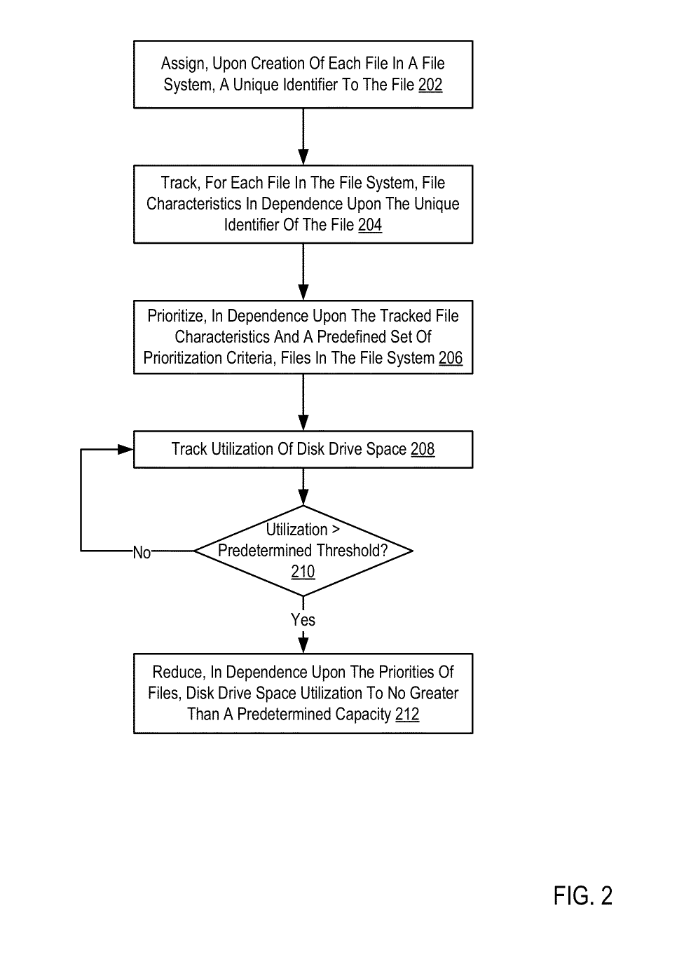

For further explanation, FIG. 2 sets forth a flow chart illustrating an exemplary method for dynamic disk space management in a file system according to embodiments of the present invention. The method of FIG. 2 includes assigning (202), by a disk utilization manager upon creation of each file in the file system, a unique identifier to the file. Assigning (202) a unique identifier to the file upon creation of the file in the file system may be carried out by storing in metadata for the file a numeric identifier, alphanumeric identifier, and so on. The disk utilization manager may, for example, maintain a counter that is incremented upon each file creation. The value of the counter may be assigned to the file upon its creation. In this way, each file in the file system may be uniquely identified from all other files. Upon copies of a file being created, the disk utilization manager may assign the original file's identifier to the copy. Here, the identifier is unique to an original file, not each copy or version of the file.

The method of FIG. 2 also includes tracking (204), by the disk utilization manager for each file in the file system, file characteristics in dependence upon the unique identifier of the file and prioritizing (206), in dependence upon the tracked file characteristics and a predefined set of prioritization criteria, files in the file system. Prioritizing files may be carried out periodically, upon creation of a file in the file system, some combination of these, or at other times. Some file characteristics may vary over time, such that priorities may be stale if not updated regularly.

The method of FIG. 2 also includes tracking (208), by the disk utilization manager, utilization of disk drive space. Tracking (208) utilization of disk drive space may be carried out in various ways, including, for example, by periodically polling the operating system for current disk utilization.

The method of FIG. 2 also includes determining (210) whether utilization of disk drive space exceeds a predetermined maximum threshold. Determining (210) whether utilization of disk drive space exceeds a predetermined maximum threshold may be carried out by comparing the utilization to the predetermined maximum threshold.

If the utilization does not exceed the predetermined maximum threshold, the method of FIG. 2 continues by the disk utilization manager taking no utilization reducing actions and instead, returning to tracking (208) utilization of disk drive space. If, however, the utilization exceeds the predetermined maximum threshold, the method of FIG. 2 continues by reducing (212), by the disk utilization manager in dependence upon the priorities of files, disk drive space utilization to no greater than a predetermined capacity. Reducing (212) disk drive space utilization to no greater than a predetermined capacity is described below in greater detail.

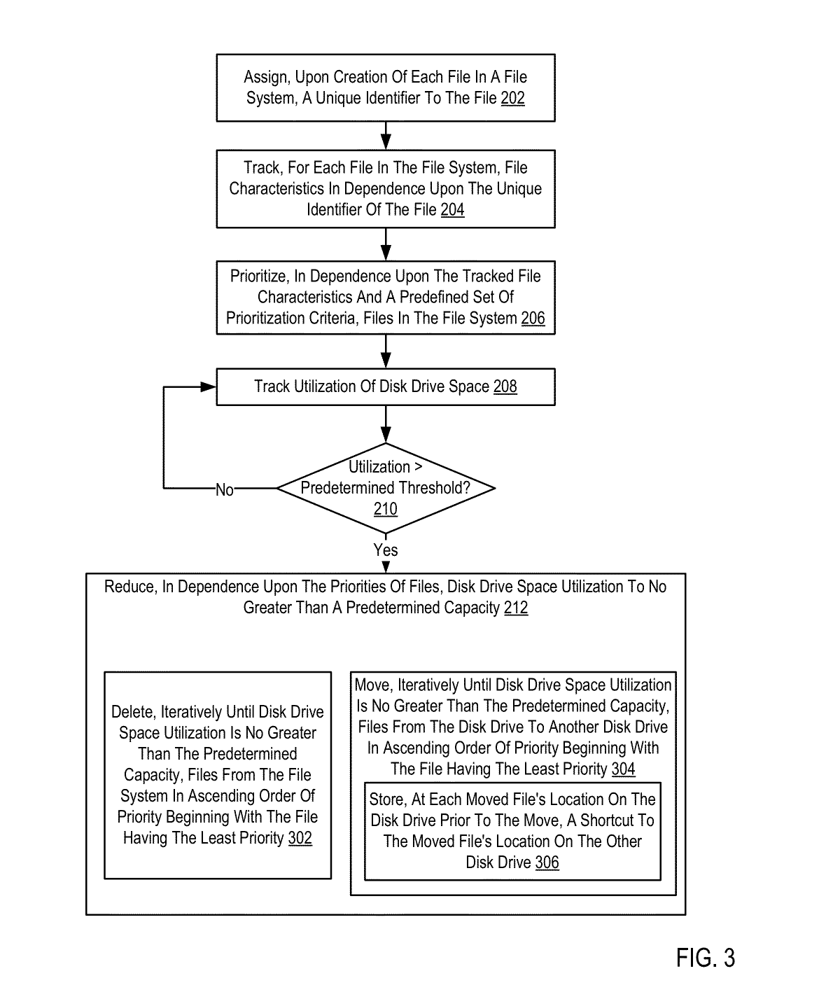

For further explanation, FIG. 3 sets forth a flow chart illustrating a further exemplary method for dynamic disk space management in a file system according to embodiments of the present invention. The method of FIG. 3 is similar to the method of FIG. 2 in that the method of FIG. 3 also includes: assigning (202) a unique identifier to a file upon creation; tracking (204) file characteristics in dependence upon the unique identifier of the file; prioritizing (206) files in the file system; tracking (208) utilization of disk drive space; determining (210) whether utilization exceeds a predetermined maximum threshold; and if so, reducing (212) disk drive space utilization to no greater than a predetermined capacity.

The method of FIG. 3 differs from the method of FIG. 2, however, in that in the method of FIG. 3, reducing (212) disk drive space utilization to no greater than a predetermined capacity may be carried out by deleting (302), iteratively until disk drive space utilization is no greater than the predetermined capacity, files from the file system in ascending order of priority beginning with the file having the least priority. Consider, for example, that prioritization criteria specifies that files having not been accessed for more than a year, with a size greater than 25 Megabytes (MB), be assigned the lowest priority relative to other files. In such an example, the disk utilization manager may begin deleting (302) the lowest priority files that match these criteria, iteratively until utilization of the disk drive space is no greater than a predetermined capacity. In some embodiments, the disk utilization manager may also store at the original location of the deleted file, a smaller file describing a method of recovering the deleted file or a shortcut to another version, copy, backup, or remotely stored copy of the file. In some embodiments, the disk utilization manager may, upon deleting a file, create an entry in a report describing the time and date of the deletion, the file type, file size, and method of recovering the deleted file at the time of deletion. Such a report may be periodically provided to a user or may be generated and provided upon request from a user.

Reducing (212) disk drive space utilization to no greater than a predetermined capacity may also be carried out by moving (306), iteratively until disk drive space utilization is no greater than the predetermined capacity, files from the disk drive to another disk drive in ascending order of priority beginning with the file having the least priority. Also in the method of FIG. 3, moving (306) files from the disk drive to another disk drive in ascending order of priority beginning with the file having the least priority includes storing (306), at each moved file's location on the disk drive prior to the move, a shortcut to the moved file's location on the other disk drive. Moving (304) files may also include to a backup, to a remote drive, to another computer via email, and the like.

Although depicted in the example of FIG. 3 as two separate steps, readers of skill in the art will recognize that methods of dynamic disk space management in a file system according to embodiments of the present invention may include a combination of deleting (302) and moving (306) files to reduce (212) disk space utilization. Such combination may be predefined by a system policy or by a user.

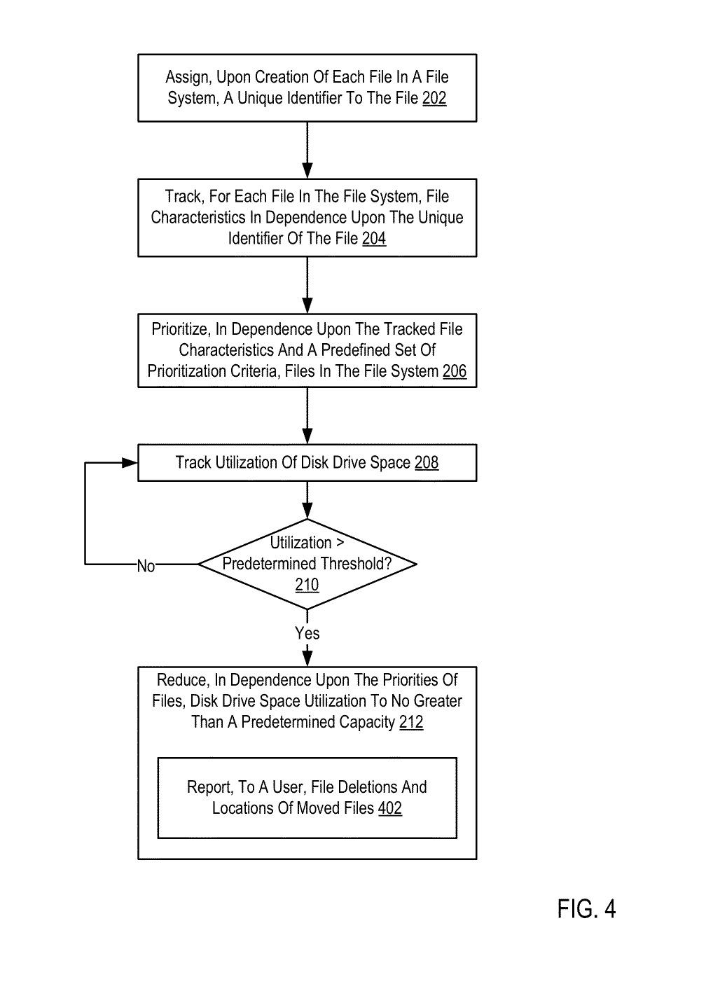

For further explanation, FIG. 4 sets forth a flow chart illustrating a further exemplary method for dynamic disk space management in a file system according to embodiments of the present invention. The method of FIG. 4 is similar to the method of FIG. 2 in that the method of FIG. 4 also includes: assigning (202) a unique identifier to a file upon creation; tracking (204) file characteristics in dependence upon the unique identifier of the file; prioritizing (206) files in the file system; tracking (208) utilization of disk drive space; determining (210) whether utilization exceeds a predetermined maximum threshold; and if so, reducing (212) disk drive space utilization to no greater than a predetermined capacity.

The method of FIG. 4 differs from the method of FIG. 2, however, in that reducing (212) disk drive space utilization to no greater than a predetermined capacity also includes reporting (402), to a user, file deletions and locations of moved files. Reporting (402) file deletions and locations of moved files may be carried out in various ways. Reporting (402) file deletions and locations of moved files, for example, may be carried out by storing information describing the deletion or move at the original file's storage location. Reporting (402) file deletions and locations of moved files, for example, may also be carried out by generating a report, periodically or at the user's behest, describing such deletions and locations of moved filed.

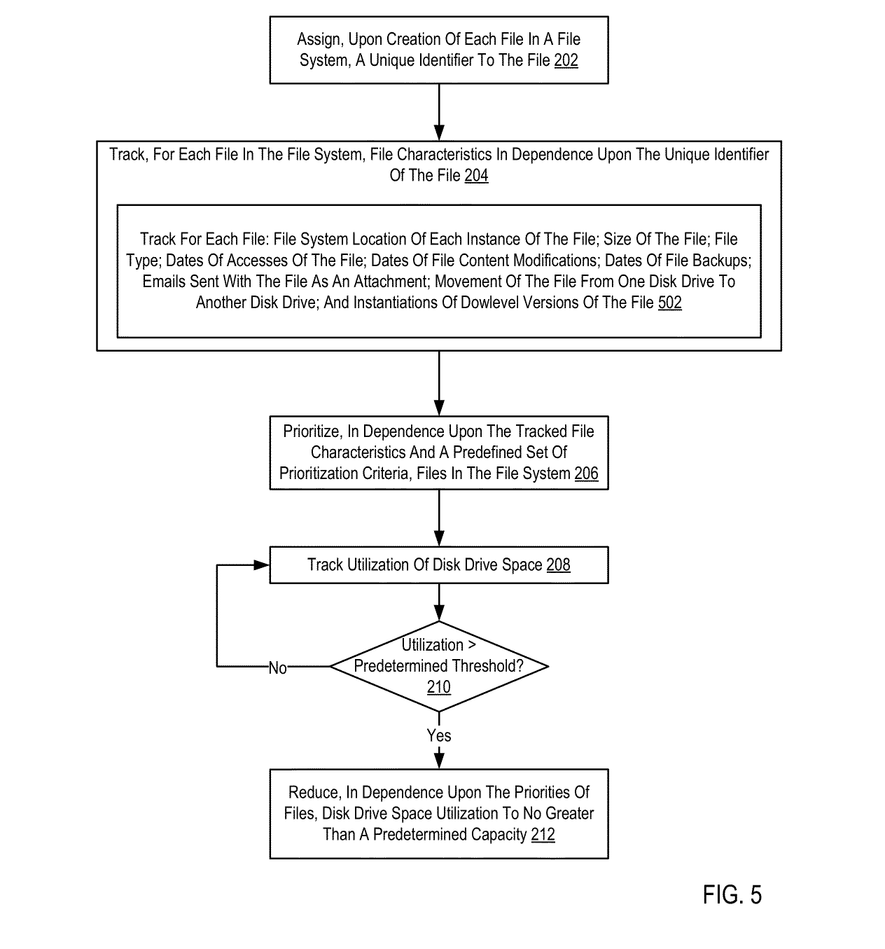

For further explanation, FIG. 5 sets forth a flow chart illustrating a further exemplary method for dynamic disk space management in a file system according to embodiments of the present invention. The method of FIG. 5 is similar to the method of FIG. 2 in that the method of FIG. 5 also includes: assigning (202) a unique identifier to a file upon creation; tracking (204) file characteristics in dependence upon the unique identifier of the file; prioritizing (206) files in the file system; tracking (208) utilization of disk drive space; determining (210) whether utilization exceeds a predetermined maximum threshold; and if so, reducing (212) disk drive space utilization to no greater than a predetermined capacity.

The method of FIG. 5 differs from the method of FIG. 2, however, in that tracking (204) file characteristics for each file is carried out by tracking for each file: file system location of each instance of the file; size of the file; file type; dates of accesses of the file; dates of file content modifications; dates of file backups; emails sent with the file as an attachment; movement of the file from one disk drive to another disk drive; and instantiations of downlevel versions of the file. In some embodiments, tracking (204) file characteristics includes tracking files across networked computers.

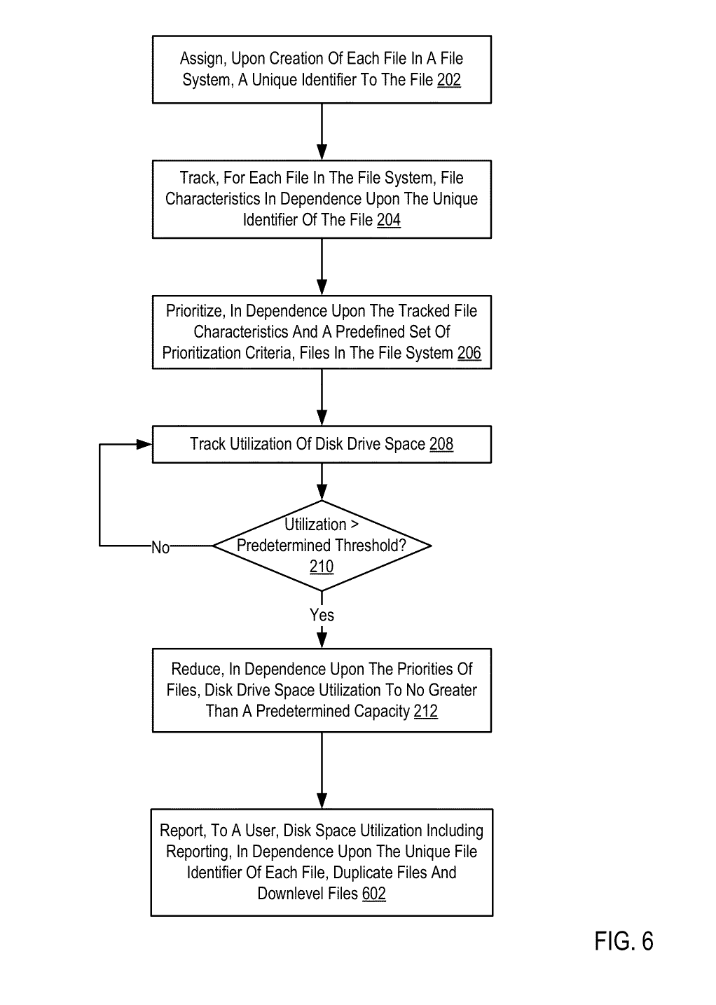

For further explanation, FIG. 6 sets forth a flow chart illustrating a further exemplary method for dynamic disk space management in a file system according to embodiments of the present invention. The method of FIG. 6 is similar to the method of FIG. 2 in that the method of FIG. 6 also includes: assigning (202) a unique identifier to a file upon creation; tracking (204) file characteristics in dependence upon the unique identifier of the file; prioritizing (206) files in the file system; tracking (208) utilization of disk drive space; determining (210) whether utilization exceeds a predetermined maximum threshold; and if so, reducing (212) disk drive space utilization to no greater than a predetermined capacity.

The method of FIG. 6 differs from the method of FIG. 2, however, in that the method of FIG. 6 also includes reporting (602), by the disk utilization manager to a user, disk space utilization. Reporting (602) disk space utilization to a user may also include reporting, in dependence upon the unique file identifier of each file, duplicate files and downlevel files. A downlevel file is separate instantiation of a previous version of a file.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of dynamic disk space management in a file system, the method comprising:
assigning, by a disk utilization manager upon creation of each file in the file system, a unique identifier to the file;
tracking, by the disk utilization manager for each file in the file system, file characteristics in dependence upon the unique identifier of the file;
prioritizing, by the disk utilization manager in dependence upon the tracked file characteristics and a predefined set of prioritization criteria, files in the file system;
tracking, by the disk utilization manager, utilization of disk drive space; and
upon utilization of disk drive space exceeding a predetermined maximum threshold, reducing, by the disk utilization manager in dependence upon the priorities of files, disk drive space utilization to no greater than a predetermined capacity.

2. The method of claim 1 wherein reducing disk drive space utilization further comprises deleting, iteratively until disk drive space utilization is no greater than the predetermined capacity, files from the file system in ascending order of priority beginning with the file having the least priority.

3. The method of claim 1 wherein reducing disk drive space utilization further comprises moving, iteratively until disk drive space utilization is no greater than the predetermined capacity, files from the disk drive to another disk drive in ascending order of priority beginning with the file having the least priority.

4. The method of claim 1 wherein moving files from the disk drive to another disk drive further comprises storing, at each moved file's location on the disk drive prior to the move, a shortcut to the moved file's location on the other disk drive.

5. The method of claim 1 wherein reducing disk drive space utilization further comprises reporting, to a user, file deletions and locations of moved files.

6. The method of claim 1 wherein tracking, for each file in the file system, file characteristics in dependence upon the unique identifier of the file further comprises: tracking for each file: file system location of each instance of the file; size of the file; file type; dates of accesses of the file; dates of file content modifications; dates of file backups; emails sent with the file as an attachment; movement of the file from one disk drive to another disk drive; and instantiations of downlevel versions of the file.

7. The method of claim 1 further comprising reporting, by the disk utilization manager to a user, disk space utilization including reporting, in dependence upon the unique file identifier of each file, duplicate files and downlevel files.

8. An apparatus for dynamic disk space management in a file system, the apparatus comprising a computer processor, a computer memory operatively coupled to the computer processor, the computer memory having disposed within it computer program instructions that, when executed by the computer processor, cause the apparatus to carry out the steps of:
assigning, by a disk utilization manager upon creation of each file in the file system, a unique identifier to the file;
tracking, by the disk utilization manager for each file in the file system, file characteristics in dependence upon the unique identifier of the file;
prioritizing, by the disk utilization manager in dependence upon the tracked file characteristics and a predefined set of prioritization criteria, files in the file system;
tracking, by the disk utilization manager, utilization of disk drive space; and
upon utilization of disk drive space exceeding a predetermined maximum threshold, reducing, by the disk utilization manager in dependence upon the priorities of files, disk drive space utilization to no greater than a predetermined capacity.

9. The apparatus of claim 9 wherein reducing disk drive space utilization further comprises deleting, iteratively until disk drive space utilization is no greater than the predetermined capacity, files from the file system in ascending order of priority beginning with the file having the least priority.

10. The apparatus of claim 9 wherein reducing disk drive space utilization further comprises moving, iteratively until disk drive space utilization is no greater than the predetermined capacity, files from the disk drive to another disk drive in ascending order of priority beginning with the file having the least priority.

11. The apparatus of claim 9 wherein moving files from the disk drive to another disk drive further comprises storing, at each moved file's location on the disk drive prior to the move, a shortcut to the moved file's location on the other disk drive.

12. The apparatus of claim 9 wherein reducing disk drive space utilization further comprises reporting, to a user, file deletions and locations of moved files.

13. The apparatus of claim 9 wherein tracking, for each file in the file system, file characteristics in dependence upon the unique identifier of the file further comprises: tracking for each file: file system location of each instance of the file; size of the file; file type; dates of accesses of the file; dates of file content modifications; dates of file backups; emails sent with the file as an attachment; movement of the file from one disk drive to another disk drive; and instantiations of downlevel versions of the file.

14. The apparatus of claim 9 further comprising computer program instructions that when executed by the computer processor cause the apparatus to carry out the step of reporting, by the disk utilization manager to a user, disk space utilization including reporting, in dependence upon the unique file identifier of each file, duplicate files and downlevel files.

15. A computer program product for dynamic disk space management in a file system, the computer program product disposed upon a computer readable medium, the computer program product comprising computer program instructions that, when executed, cause a computer to carry out the steps of:
assigning, by a disk utilization manager upon creation of each file in the file system, a unique identifier to the file;
tracking, by the disk utilization manager for each file in the file system, file characteristics in dependence upon the unique identifier of the file;
prioritizing, by the disk utilization manager in dependence upon the tracked file characteristics and a predefined set of prioritization criteria, files in the file system;
tracking, by the disk utilization manager, utilization of disk drive space; and
upon utilization of disk drive space exceeding a predetermined maximum threshold, reducing, by the disk utilization manager in dependence upon the priorities of files, disk drive space utilization to no greater than a predetermined capacity.

16. The computer program product of claim 15 wherein reducing disk drive space utilization further comprises deleting, iteratively until disk drive space utilization is no greater than the predetermined capacity, files from the file system in ascending order of priority beginning with the file having the least priority.

17. The computer program product of claim 15 wherein reducing disk drive space utilization further comprises moving, iteratively until disk drive space utilization is no greater than the predetermined capacity, files from the disk drive to another disk drive in ascending order of priority beginning with the file having the least priority.

18. The computer program product of claim 15 wherein moving files from the disk drive to another disk drive further comprises storing, at each moved file's location on the disk drive prior to the move, a shortcut to the moved file's location on the other disk drive.

19. The computer program product of claim 15 wherein reducing disk drive space utilization further comprises reporting, to a user, file deletions and locations of moved files.

20. The computer program product of claim 15 wherein tracking, for each file in the file system, file characteristics in dependence upon the unique identifier of the file further comprises: tracking for each file: file system location of each instance of the file; size of the file; file type; dates of accesses of the file; dates of file content modifications; dates of file backups; emails sent with the file as an attachment; movement of the file from one disk drive to another disk drive; and instantiations of downlevel versions of the file.

21. The computer program product of claim 15 further comprising computer program instructions that when executed by the computer processor cause the computer to carry out the step of reporting, by the disk utilization manager to a user, disk space utilization including reporting, in dependence upon the unique file identifier of each file, duplicate files and downlevel files.
